(19) United States
(12) Patent Application Publication
(10) Pub. No.: US 2008/0005142 A1
(43) Pub. Date: Jan. 3, 2008

(54) Systems and methods for array content information exchange

(76) Inventors: Charles F. Nelson, San Carlos, CA (US); Amitabh Shukla, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/479,014

(22) Filed: Jun. 29, 2006

(51) Int. Cl. G06F 7/00

(52) U.S. Cl. 707/101

(57) ABSTRACT

Systems and methods for using the same to exchange array content information are provided. Also provided are computer program products for executing the subject methods.

### BACKGROUND

Arrays of chemical binding agents, such as nucleic acids and polypeptides, have become an increasingly important tool in the biotechnology industry and related fields. These chemical (i.e., binding agent or ligand) arrays, in which a plurality of chemical binding agents are positioned on a solid support surface in the form of an array or pattern, find use in a variety of applications, including gene expression analysis, drug screening, nucleic acid sequencing, mutation analysis, comparative genome hybridization, location analysis and the like.

### SUMMARY OF THE INVENTION

Aspects of the subject invention include systems and methods for using the same to exchange array content information.

In certain embodiments, the invention provides a system for exchanging array content information which includes:
(a) a database containing array content information;
(b) a communication module; and
(c) a processing module containing an array content information manager configured to process array content information requests of the database by a user.

In certain embodiments, the array content information manager requires qualifying information from a user prior to processing array content information requests of the database by the user.

In certain embodiments, the qualifying information is selected form the group consisting of: name, email address, affiliation, contact information, and job title.

In certain embodiments, the array content information requests are selected from the group consisting of: submission of array content information, retrieval of array content information based on a query, deletion of array content information, modification of array content information, and providing comments on array content information.

In certain embodiments, the array content information manager is configured to require submission of array content information to the database by a user prior to allowing retrieval of array content information from the database in response to a query from the user.

In certain embodiments, the array content information contains probe-level information.

In certain embodiments, the probe-level information is selected from the group consisting of: sequence, annotation, length, and target binding characteristics.

In certain embodiments, the array content information contains array-level information.

In certain embodiments, the array-level information is selected from the group consisting of: probe-specific information for at least a subset of probes on an array, intended use of an array, target organism, array layout, and protocol for using an array.

In certain embodiments, the array content information manager communicates to a user array content information retrieved in response to a query from the user.

In certain embodiments, the array content information manager displays retrieved array content information for selection by the user.

In certain embodiments, the system also contains a user domain for the user, wherein the array content information manager stores the retrieved array content information selected by the user in the user domain.

In certain embodiments, the system further contains an array layout developer, wherein the array layout developer develops an array layout based at least in part on the stored array content information in the user domain when prompted by the user.

In certain embodiments, the array content information manager communicates the developed array layout to the user.

In certain embodiments, the array content information manager stores the developed array layout in the user domain when prompted by the user.

In certain embodiments, the system further contains an array fabrication module, wherein the array fabrication module fabricates at least one array based on the developed array layout when prompted by the user.

In certain embodiments, the array content information manager prompts a user to complete an incomplete an array content information submission prior to storing the array content information submission in the database.

In certain embodiments, the array content information contains proprietary and/or non-proprietary array content information.

In certain embodiments, the array content information manager is configured to be controlled by an administrator of the system.

In certain embodiments, a first user can access array content information in the database submitted by a second user.

In certain embodiments, the communication module is configured to provide for remote communication between the processing module and a user.

In certain embodiments, the communication module provides for communication between the user and the processing module via the Internet.

In certain embodiments, the communication module provides for a graphical user interface (GUI) between the user and the processing module.

In certain embodiments, the invention provides a method of exchanging array content information, including:
(a) accessing a system of the invention (e.g., as described above); and
(b) submitting an array content information request to the system.

In certain embodiments, the accessing is via the Internet.

In certain embodiments, the accessing is via a graphical user interface.

In certain embodiments, the accessing requires providing qualifying information.

In certain embodiments, the array content information request is selected from the group consisting of: submission of array content information, retrieval of array content information based on a query, deletion of array content information, modification of array content information, and providing comments on array content information.

In certain embodiments, the array content information contains probe-level information.

In certain embodiments, the probe-level information is selected from the group consisting of: sequence, annotation, length, and target binding characteristics.

In certain embodiments, the array content information contains array-level information.

In certain embodiments, the array-level information is selected from the group consisting of: probe-level information for at least a subset of probes on an array, intended use of an array, target organism, array layout, array format, and protocol for using an array.

In certain embodiments, the invention provides a method of producing an array layout for a chemical array, including:
(a) accessing a system of the invention having an array layout developer (e.g., as described above);
(b) retrieving array content information;
(c) prompting the system to develop an array layout based at least in part on the retrieved array content information; and
(d) obtaining an array layout from the system to produce the array layout.

In certain embodiments, accessing the system is via the Internet.

In certain embodiments, accessing the system is via a graphical user interface.

In certain embodiments, the method further includes fabricating one or more chemical arrays having the array layout.

In certain embodiments, the method further includes shipping the one or more chemical arrays to a user.

In certain embodiments, the invention provides a computer program product containing a computer readable storage medium having a computer program stored thereon, wherein the computer program, when loaded onto a computer, operates the computer to:
(a) establish a database containing array content information; and
(b) process array content information requests of the database by a user.

### BRIEF DESCRIPTIONS OF THE DRAWINGS

FIG. 1 illustrates a substrate carrying multiple arrays, such as may be fabricated by methods of the present invention.

FIG. 2 is an enlarged view of a portion of FIG. 1 showing multiple ideal spots or features.

FIG. 3 is an enlarged illustration of a portion of the substrate in FIG. 2.

FIG. 4 schematically illustrates an exemplary system of the present invention.

FIG. 5 is a flowchart exemplifying certain aspects of the implementation of a system of the present invention.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

By “array layout” is meant a collection of information, e.g., in the form of a file, which represents the location of probes that have been assigned to specific features of one or more array formats, e.g., a single array format or two or more array formats of an array set.

The phrase “array format” refers to a format that defines an array by feature number, feature size, Cartesian coordinates of each feature, and distance that exists between features within a given single array.

The phrase “array content information” is used to refer to any type of information/data that describes an array. Representative types of array content information include, but are not limited to: “probe-level information” and “array-level information”. By “probe-level information” is meant any information relating to the biochemical properties or descriptive characteristics of a probe. Examples include, but are not limited to: probe sequence, melting temperature (Tₘ), target gene or genes (e.g., gene name, accession number, etc.), location identifier information, information regarding cell(s) or tissue(s) in which a probe sequence is expressed and/or levels of expression, information concerning physiological responses of a cell or tissue in which the sequence is expressed (e.g., whether the cell or tissue is from a patient with a disease), chromosomal location information, copy number information, information relating to similar sequences (e.g., homologous, paralogous or orthologous sequences), frequency of the sequence in a population, information relating to polymorphic variants of the probe sequence (e.g., such as SNPs), information relating to splice variants (e.g., tissues, individuals in which such variants are expressed), demographic information relating to individual(s) in which the sequence is found, and/or other annotation information. By “array-level information” is meant information relating to the physical properties or intended use of an array. Examples include, but are not limited to: types of genes to be studied using the array, such as genes from a specific species (e.g., mouse, human), genes associated with specific tissues (e.g., liver, brain, cardiac), genes associated with specific physiological functions, (e.g., apoptosis, stress response), genes associated with disease states (e.g., cancer, cardiovascular disease), array format information, e.g., feature number, feature size, Cartesian coordinates of each feature, and distance that exists between features within a given array, etc.

A “data element” represents a property of a probe sequence, which can include the base composition of the probe sequence. Data elements can also include representations of other properties of probe sequences, such as expression levels in one or more tissues, interactions between a sequence (and/or its encoded products), and other molecules, a representation of copy number, a representation of the relationship between its activity (or lack thereof) in a cellular pathway (e.g., a signaling pathway) and a physiological response, sequence similarity to other probe sequences, a representation of its function, a representation of its modified, processed, and/or variant forms, a representation of splice variants, the locations of introns and exons, functional domains etc. A data element can be represented for example, by an alphanumeric string (e.g., representing bases), by a number, by “plus” and “minus” symbols or other symbols, by a color hue, by a word, or by another form (descriptive or nondescriptive) suitable for computation, analysis and/or processing for example, by a computer or other machine or system capable of data integration and analysis.

As used herein, the term “data structure” is intended to mean an organization of information, such as a physical or logical relationship among data elements, designed to support specific data manipulation functions, such as an algorithm. The term can include, for example, a list or other collection type of data elements that can be added, subtracted, combined or otherwise manipulated. Exemplarily, types of data structures include a list, linked-list, doubly linked-list, indexed list, table, matrix, queue, stack, heap, dictionary, flat file databases, relational databases, local databases, distributed databases, thin client databases and tree. The term also can include organizational structures of information that relate or correlate, for example, data elements from a plurality of data structures or other forms of data management structures. A specific example of information organized by a data structure of the invention is the association of a plurality of data elements relating to a gene, e.g., its sequence, expression level in one or more tissues, copy number, activity states (e.g., active or non-active in one or more tissues), its modified, processed and/or and/or variant forms, splice variants encoded by the gene, the locations of introns and exons, functional domains, interactions with other molecules, function, sequence similarity to other probe sequences, etc. A data structure can be a recorded form of information (such as a list) or can contain additional information (e.g., annotations) regarding the information contained therein. A data structure can include pointers or links to resources external to the data structure (e.g., such as external databases). In one aspect, a data structure is embodied in a tangible form, e.g. is stored or represented in a tangible medium (such as a computer readable medium).

The term “object” refers to a unique concrete instance of an abstract data type, a class (that is, a conceptual structure including both data and the methods to access it) whose identity is separate from that of other objects, although it can “communicate” with them via messages. In some occasions, some objects can be conceived of as a subprogram which can communicate with others by receiving or giving instructions based on its, or the others' data or methods. Data can consist of numbers, literal strings, variables, references, etc. In addition to data, an object can include methods for manipulating data. In certain instances, an object may be viewed as a region of storage. In the present invention, an object typically includes a plurality of data elements and methods for manipulating such data elements.

A “relation” or “relationship” is an interaction between multiple data elements and/or data structures and/or objects. A list of properties may be attached to a relation. Such properties may include name, type, location, etc. A relation may be expressed as a link in a network diagram. Each data element may play a specific “role” in a relation.

As used herein, an “annotation” is a comment, explanation, note, link, or metadata about a data element, data structure or object, or a collection thereof. Annotations may include pointers to external objects or external data. An annotation may optionally include information about an author who created or modified the annotation, as well as information about when that creation or modification occurred. In one embodiment, a memory comprising a plurality of data structures organized by annotation category provides a database through which information from multiple databases, public or private, may be accessed, assembled, and processed. Annotation tools include, but are not limited to, software such as BioFerret (available from Agilent Technologies, Inc., Palo Alto, Calif.), which is described in detail in application Ser. No. 10/033,823 filed Dec. 19, 2001 and titled “Domain-Specific Knowledge-Based Metasearch System and Methods of Using.” Such tools may be used to generate a list of associations between genes from scientific literature and patent publications.

As used herein an “annotation category” is a human readable string to annotate the logical type the object comprising its plurality of data elements represents. Data structures that contain the same types and instances of data elements may be assigned identical annotations, while data structures that contain different types and instances of data elements may be assigned different annotations.

As used herein, a “probe sequence identifier” or an “identifier corresponding to a probe sequence” refers to a string of one or more characters (e.g., alphanumeric characters), symbols, images or other graphical representation(s) associated with a probe sequence comprising a probe sequence such that the identifier provides a “shorthand” designation for the sequence. In one aspect, an identifier comprises an accession number or a clone number. An identifier may comprise descriptive information. For example, an identifier may include a reference citation or a portion thereof.

The phrase “best-fit” refers to a resource allocation scheme that determines the best result in response to input data. The definition of ‘best’ may vary depending on a given set of predetermined parameters, such as sequence identity limits, signal intensity limits, cross-hybridization limits, Tₘ, base composition limits, probe length limits, distribution of bases along the length of the probe, distribution of nucleation points along the length of the probe (e.g., regions of the probe likely to participate in hybridization, secondary structure parameters, etc. In one aspect, the system considers predefined thresholds. In another aspect, the system rank-orders fit. In a further aspect, the user defines his or her own thresholds, which may or may not include system-defined threshold.

The terms “system” and “computer-based system” refer to the hardware means, software means, and data storage means used to analyze the information of the present invention. The minimum hardware of the computer-based systems of the present invention comprises a central processing unit (CPU), input means, output means, and data storage means. As such, any convenient computer-based system may be employed in the present invention. The data storage means may comprise any manufacture comprising a recording of the present information as described above, or a memory access means that can access such a manufacture.

A “processor” references any hardware and/or software combination which will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station. “Computer readable medium” as used herein refers to any storage or transmission medium that participates in providing instructions and/or data to a computer for execution and/or processing. Examples of storage media include floppy disks, magnetic tape, UBS, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer. A file may be stored in permanent memory.

With respect to computer readable media, “permanent memory” refers to memory that is permanently stored on a data storage medium. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

To “record” data, programming or other information on a computer readable medium refers to a process for storing information, using any convenient method. Any convenient data storage structure may be chosen, based on the means used to access the stored information. A variety of data processor programs and formats can be used for storage, e.g. word processing text file, database format, etc.

A “memory” or “memory unit” refers to any device which can store information for subsequent retrieval by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

In certain embodiments, a system includes hardware components which take the form of one or more platforms, e.g., in the form of servers, such that any functional elements of the system, i.e., those elements of the system that carry out specific tasks (such as managing input and output of information, processing information, etc.) of the system may be carried out by the execution of software applications on and across the one or more computer platforms represented of the system. The one or more platforms present in the subject systems may be any convenient type of computer platform, e.g., such as a server, main-frame computer, a work station, etc. Where more than one platform is present, the platforms may be connected via any convenient type of connection, e.g., cabling or other communication system including wireless systems, either networked or otherwise. Where more than one platform is present, the platforms may be co-located or they may be physically separated. Various operating systems may be employed on any of the computer platforms, where representative operating systems include Windows, Sun Solaris, Linux, OS/400, Compaq Tru64 Unix, SGI IRIX, Siemens Reliant Unix, and others. The functional elements of system may also be implemented in accordance with a variety of software facilitators, platforms, or other convenient method.

Items of data are “linked” to one another in a memory when the same data input (for example, filename or directory name or search term) retrieves the linked items (in a same file or not) or an input of one or more of the linked items retrieves one or more of the others.

The term “monomer” as used herein refers to a chemical entity that can be covalently linked to one or more other such entities to form a polymer. Of particular interest to the present application are nucleotide “monomers” that have first and second sites (e.g., 5′ and 3′ sites) suitable for binding to other like monomers by means of standard chemical reactions (e.g., nucleophilic substitution), and a diverse element which distinguishes a particular monomer from a different monomer of the same type (e.g., a nucleotide base, etc.). In general, synthesis of nucleic acids of this type utilizes an initial substrate-bound monomer that is used as a building-block in a multi-step synthesis procedure to form a complete nucleic acid. A “biomonomer” references a single unit, which can be linked with the same or other biomonomers to form a biopolymer (e.g., a single amino acid or nucleotide with two linking groups, one or both of which may have removable protecting groups).

The terms “nucleoside” and “nucleotide” are intended to include those moieties which contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

As used herein, the term “amino acid” is intended to include not only the L, D- and nonchiral forms of naturally occurring amino acids (alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine), but also modified amino acids, amino acid analogs, and other chemical compounds which can be incorporated in conventional oligopeptide synthesis, e.g., 4-nitrophenylalanine, isoglutamic acid, isoglutamine, ε-nicotinoyl-lysine, isonipecotic acid, tetrahydroisoquinoleic acid, α-aminoisobutyric acid, sarcosine, citrulline, cysteic acid, t-butylglycine, t-butylalanine, phenylglycine, cyclohexylalanine, , β-alanine, 4-aminobutyric acid, and the like.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other polynucleotides which are C-glycosides of a purine or pyrimidine base, polypeptides (proteins), polysaccharides (starches, or polysugars), and other chemical entities that contain repeating units of like chemical structure. In the practice of the instant invention, oligomers will generally comprise about 2-50 monomers, preferably about 2-20, more preferably about 3-10 monomers.

The term “polymer” means any compound that is made up of two or more monomeric units covalently bonded to each other, where the monomeric units may be the same or different, such that the polymer may be a homopolymer or a heteropolymer. Representative polymers include peptides, polysaccharides, nucleic acids and the like, where the polymers may be naturally occurring or synthetic.

A “biopolymer” is a polymer of one or more types of repeating units. Biopolymers are typically found in biological systems (although they may be made synthetically) and may include peptides or polynucleotides, as well as such compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. For example, a “biopolymer” may include DNA (including cDNA), RNA, oligonucleotides, and PNA and other polynucleotides as described in U.S. Pat. No. 5,948,902 and references cited therein (all of which are incorporated herein by reference), regardless of the source.

The term “biomolecule” means any organic or biochemical molecule, group or species of interest that may be formed in an array on a substrate surface. Exemplary biomolecules include peptides, proteins, amino acids and nucleic acids.

The term “ligand” as used herein refers to a moiety that is capable of covalently or otherwise chemically binding a compound of interest. The arrays of solid-supported ligands produced by the methods can be used in screening or separation processes, or the like, to bind a component of interest in a sample. The term “ligand” in the context of the invention may or may not be an “oligomer” as defined above. However, the term “ligand” as used herein may also refer to a compound that is “pre-synthesized” or obtained commercially, and then attached to the substrate.

The term “sample” as used herein relates to a material or mixture of materials, typically, although not necessarily, in fluid form, containing one or more components of interest.

A biomonomer fluid or biopolymer fluid refers to a liquid containing either a biomonomer or biopolymer, respectively (typically in solution).

The term “peptide” as used herein refers to any polymer compound produced by amide formation between an α-carboxyl group of one amino acid and an α-amino group of another group.

The term “oligopeptide” as used herein refers to peptides with fewer than about 10 to 20 residues, i.e., amino acid monomeric units.

The term “polypeptide” as used herein refers to peptides with more than 10 to 20 residues.

The term “protein” as used herein refers to polypeptides of specific sequence of more than about 50 residues.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single-stranded nucleotide multimers of from about 10 up to about 200 nucleotides in length, e.g., from about 25 to about 200 nt, including from about 50 to about 175 nt, e.g. 150 nt in length

The term “polynucleotide” as used herein refers to single- or double-stranded polymers composed of nucleotide monomers of generally greater than about 100 nucleotides in length.

An “array,” or “chemical array” used interchangeably includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), polypeptides (e.g., proteins), carbohydrates, lipids, etc.) associated with that region. As such, an addressable array includes any one or two or even three-dimensional arrangement of discrete regions (or “features”) bearing particular biopolymer moieties (for example, different polynucleotide sequences) associated with that region and positioned at particular predetermined locations on the substrate (each such location being an “address”). These regions may or may not be separated by intervening spaces. In the broadest sense, the arrays of many embodiments are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations.

Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays may be fabricated using drop deposition from pulse jets of either precursor units (such as nucleotide or amino acid monomers) in the case of in situ fabrication, or the previously obtained biomolecule, e.g., polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein.

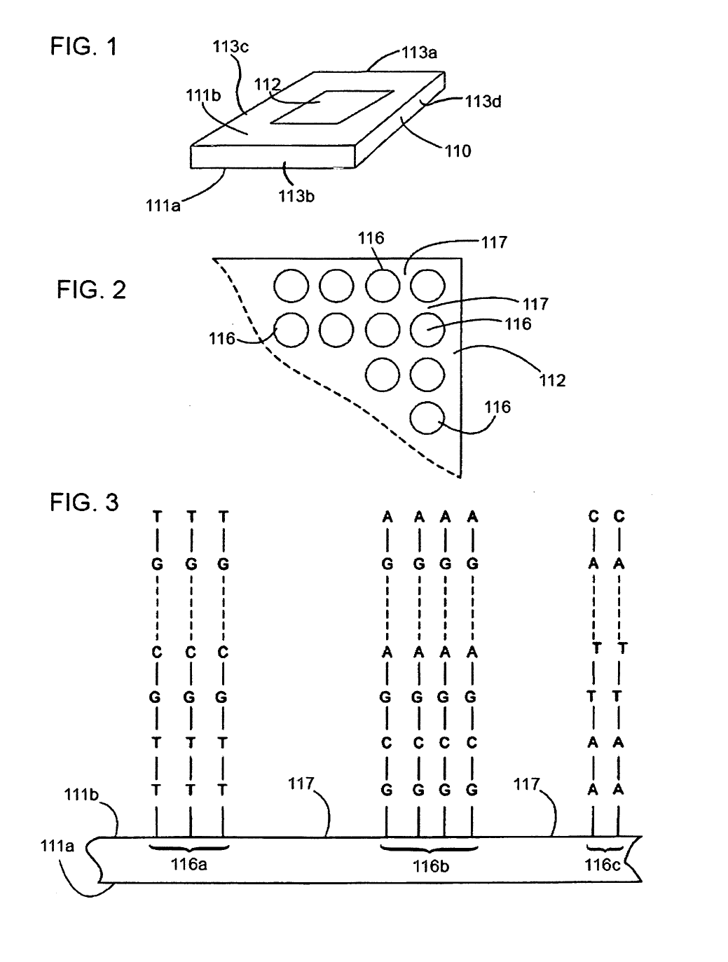

An exemplary chemical array is shown in FIGS. 1-3, where the array shown in this representative embodiment includes a contiguous planar substrate 110 carrying an array 112 disposed on a surface 111b of substrate 110. It will be appreciated though, that more than one array (any of which are the same or different) may be present on surface 111b, with or without spacing between such arrays. That is, any given substrate may carry one, two, four or more arrays disposed on a front surface of the substrate and depending on the use of the array, any or all of the arrays may be the same or different from one another and each may contain multiple spots or features. The one or more arrays 112 usually cover only a portion of the surface 111b, with regions of the rear surface 111b adjacent the opposed sides 113c, 113d and leading end 113a and trailing end 113b of slide 110, not being covered by any array 112. A second surface 111a of the slide 110 does not carry any arrays 112. Each array 112 can be designed for testing against any type of sample, whether a trial sample, reference sample, a combination of them, or a known mixture of biopolymers such as polynucleotides. Substrate 110 may be of any shape, as mentioned above.

As mentioned above, array 112 contains multiple spots or features 116 of biopolymer ligands, e.g., in the form of polynucleotides. As mentioned above, all of the features 116 may be different, or some or all could be the same. The interfeature areas 117 could be of various sizes and configurations. Each feature carries a predetermined biopolymer such as a predetermined polynucleotide (which includes the possibility of mixtures of polynucleotides). It will be understood that there may be a linker molecule (not shown) between the rear surface 111b and the first nucleotide. Any convenient linker may be used.

Substrate 110 may carry on surface 111a, an identification code, e.g., in the form of bar code (not shown) or the like printed on a substrate in the form of a paper label attached by adhesive or any convenient means. The identification code contains information relating to array 112, where such information may include, but is not limited to, an identification of array 112, i.e., layout information relating to the array(s), etc.

The substrate may be porous or non-porous. The substrate may have a planar or non-planar surface.

In those embodiments where an array includes two more features immobilized on the same surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., polynucleotides, to be evaluated by binding with the other).

An array “assembly” includes a substrate and at least one chemical array, e.g., on a surface thereof. Array assemblies may include one or more chemical arrays present on a surface of a device that includes a pedestal supporting a plurality of prongs, e.g., one or more chemical arrays present on a surface of one or more prongs of such a device. An assembly may include other features (such as a housing with a chamber from which the substrate sections can be removed). “Array unit” may be used interchangeably with “array assembly”.

The term “substrate” as used herein refers to a surface upon which marker molecules or probes, e.g., an array, may be adhered. Glass slides are the most common substrate for biochips, although fused silica, silicon, plastic and other materials are also suitable.

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. “Stably attached” or “stably associated with” means an item's position remains substantially constant where in certain embodiments it may mean that an item's position remains substantially constant and known.

A “web” references a long continuous piece of substrate material having a length greater than a width. For example, the web length to width ratio may be at least 5/1, 10/1, 50/1, 100/1, 200/1, or 500/1, or even at least 1000/1.

“Flexible” with reference to a substrate or substrate web, refers to a substrate can be bent 180 degrees around a roller of less than 1.25 cm in radius. The substrate can be so bent and straightened repeatedly in either direction at least 100 times without failure (for example, cracking) or plastic deformation. This bending must be within the elastic limits of the material. The foregoing test for flexibility is performed at a temperature of 20° C.

“Rigid” refers to a material or structure which is not flexible, and is constructed such that a segment about 2.5 by 7.5 cm retains its shape and cannot be bent along any direction more than 60 degrees (and often not more than 40, 20, 10, or 5 degrees) without breaking.

The terms “hybridizing specifically to” and “specific hybridization” and “selectively hybridize to,” as used herein refer to the binding, duplexing, or hybridizing of a nucleic acid molecule preferentially to a particular nucleotide sequence under stringent conditions.

“Hybridizing” and “binding”, with respect to polynucleotides, are used interchangeably.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1 M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions sets forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions may also be employed, as appropriate.

“Contacting” means to bring or put together. As such, a first item is contacted with a second item when the two items are brought or put together, e.g., by touching them to each other.

“Depositing” means to position, place an item at a location—or otherwise cause an item to be so positioned or placed at a location. Depositing includes contacting one item with another. Depositing may be manual or automatic, e.g., “depositing” an item at a location may be accomplished by automated robotic devices.

By “remote location,” it is meant a location other than the location at which the array (or referenced item) is present and hybridization occurs (in the case of hybridization reactions). For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

“Communicating” information means transmitting the data representing that information as signals (e.g., electrical, optical, radio signals, and the like) over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

An array “package” may be the array plus only a substrate on which the array is deposited, although the package may include other features (such as a housing with a chamber).

A “chamber” references an enclosed volume (although a chamber may be accessible through one or more ports). It will also be appreciated that throughout the present application, that words such as “top,” “upper,” and “lower” are used in a relative sense only.

It will also be appreciated that throughout the present application, that words such as “cover”, “base” “front”, “back”, “top”, are used in a relative sense only. The word “above” used to describe the substrate and/or flow cell is meant with respect to the horizontal plane of the environment, e.g., the room, in which the substrate and/or flow cell is present, e.g., the ground or floor of such a room.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

### DETAILED DESCRIPTION

Systems and methods for exchanging array content information are provided. The subject systems include a database for storing array content information, a communications module and a processing module, where the processing module includes an array content information manager configured to process array content information requests of the database by a user. In certain embodiments, the array content information manager is further configured to approve a user to access the system. In certain embodiments, the system further includes a user domain for saving selected results retrieved from user queries. In certain embodiments, the system further includes an array layout developer for developing array layouts based at least in part on array content information saved in the user domain. In certain embodiments, the system further includes an array fabrication station for fabricating arrays having features arranged according to an array layout retrieved from the database of the system and/or developed by the array layout developer. The methods of the invention are drawn to using the system to exchange array content information. In certain embodiments, the methods further include shipping such arrays, e.g., to a user of the system or third party. Also provided are computer program products for executing the subject methods.

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

In the event that one or more of the incorporated literature and similar materials differs from or contradicts this application, including but not limited to defined terms, term usage, described techniques, or the like, this application controls.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Aspects of the invention include systems and methods for exchanging array content information. Representative embodiments of the subject systems generally include the following components: (a) a database of array content information; (b) a communications module for facilitating information transfer between the system and one or more users, e.g., via a user computer, as described below; and (c) a processing module for performing one or more tasks in response to information received via the communications module of the system. In representative embodiments, the subject systems may be viewed as being the physical embodiment of a web portal, where the term “web portal” refers to a web site or service, e.g., as may be viewed in the form of a web page, that offers a broad array of resources and services to users via an electronic communication element, e.g., via the Internet.

In certain embodiments, the subject systems are components of array development systems, including but not limited to those systems described in Published United States Application publication Nos. 20060116827; 20060116825 and 20060115822, as well as U.S. application Ser. Nos: 11/349,425 and 11/349,398; the disclosures of which are herein incorporated by reference.

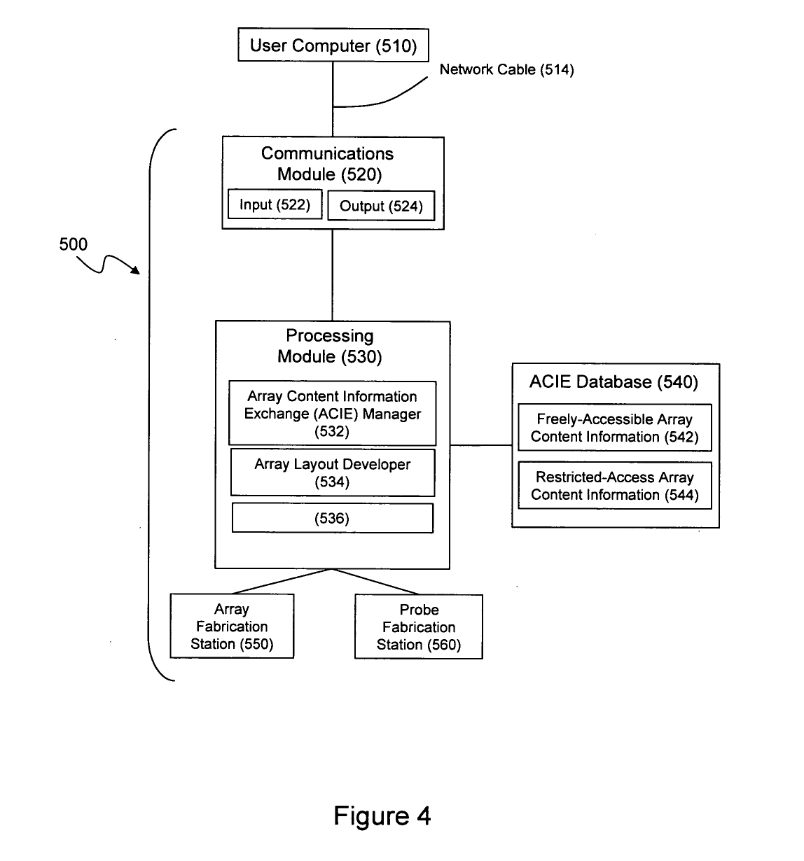

FIG. 4 provides a view of a representative array content information exchange (ACIE) system according to an embodiment of the subject invention. In FIG. 4, system 500 includes communications module 520 and processing module 530, where each module may be present on the same or different platforms, e.g., servers, as described above. The communications module includes the input manager 522 and output manager 524 functional elements.

Input manager 522 receives information, e.g., array content request information, from a user e.g., over the Internet. Input manager 522 processes and forwards this information to the processing module 530. These functions are implemented using any convenient method or technique. Another of the functional elements of communications module 520 is output manager 524. Output manager 524 provides information assembled by processing module 530, e.g., array content information, to a user, e.g., over the Internet. The presentation of data by the output manager may be implemented in accordance with any convenient methods or techniques. As some examples, data may include SQL, HTML or XML documents, email or other files, or data in other forms. The data may include Internet URL addresses so that a user may retrieve additional SQL, HTML, XML, or other documents or data from remote sources.

The communications module 520 may be operatively connected to a user computer 510, which provides a vehicle for a user to interact with the system 500. User computer 510, shown in FIG. 4, may be a computing device specially designed and configured to support and execute any of a multitude of different applications. Computer 510 also may be any of a variety of types of general-purpose computers such as a personal computer, network server, workstation, or other computer platform now or later developed. Computer 510 may include components such as a processor, an operating system, a graphical user interface (GUI) controller, a system memory, memory storage devices, and input-output controllers. There are many possible configurations of the components of computer 510 and some components are not listed above, such as cache memory, a data backup unit, and many other devices.

In certain embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein may be accomplished using any convenient method and techniques.

During use, a user employs the user computer to enter information into and retrieve information from the system. As shown in FIG. 4, computer 510 is coupled via network cable 514 to the system 500. Additional computers of other users and/or administrators of the system in a local or wide-area network including an Intranet, the Internet, or any other network may also be coupled to system 500 via cable 514. It will be understood that cable 514 is merely representative of any type of network connectivity, which may involve cables, transmitters, relay stations, network servers, wireless communication devices, and many other components not shown suitable for the purpose. Via user computer 510, a user may operate a web browser served by a user-side Internet client to communicate via Internet with system 500. System 500 may similarly be in communication over Internet with other users, networks of users, and/or system administrators, as desired.

As reviewed above, the systems include various functional elements that carry out specific tasks on the platforms in response to information introduced into the system by one or more users. In FIG. 4, elements 532, 534 and 536 represent three different functional elements of processing module 530. While three different functional elements are shown, it is noted that the number of functional elements may be more or less, depending on the particular embodiment of the invention. Representative functional elements that may be carried out by the processing module are now reviewed in greater detail below.

In certain embodiments, the subject system includes an array content information exchange (ACIE) database 540 and an ACIE manager 532 as part of the processing module 530 which is configured to perform functions relating to management of array content information in database 540. As described in detail below, in certain embodiments, the ACIE manager is configured to process array content information requests from a user. Array content information requests include both submissions of array content information to the database and queries for array content information from the database. In certain embodiments, the ACIE manager is configured to approve a user to access the ACIE database

In certain embodiments, the system 500 of the invention contains an array layout developer 534 as a component of the processing module 530 which is configured to develop an array layout for a user. By “array layout” is meant a collection of information, e.g., in the form of a file, that represents the location of probes that have been assigned to specific features of an array format or formats. The phrase “array format” refers to a format that defines an array by feature number, feature size, Cartesian coordinates of each feature, and distance that exists between features within a given array. An exemplary embodiment of an array layout developer is disclosed in U.S. patent application Ser. No. 11/349,452, filed on Feb. 6, 2006, which is incorporated herein by reference in its entirety.

In certain embodiments, ACIE database 540 contains freely-accessible array content information (542) (sometimes referred to herein as non-proprietary array content information). By “freely-accessible” array content information is meant that the user who submitted the array content information does not considered himself or herself to own, possess, or hold exclusive legal/intellectual rights to the array content information. As such, any user of the system has full access to all information related to freely-accessible array content information and therefore, using this information is not predicated on a terms-of-use agreement and/or payment of a fee to the user who submitted the array content information.

In certain embodiments, array content information database 540 contains restricted-access array content information (544) (sometimes referred to herein as proprietary array content information). By “restricted-access” array content information is meant that the user who submitted the array content information considers himself or herself to own, possess, or hold exclusive legal/intellectual rights to the array content information. In certain of these embodiments, restricted-access array content information can be accessed and/or used by a user of the system in exchange for a fee or other terms-of-use agreement with the user who submitted the restricted-access array content information. Exemplary systems and methods for exchanging restricted-access/proprietary array content information are described in co-pending U.S. patent application Ser. No. ______ entitled “System and Method for Proprietary Array Content Information Exchange” having attorney docket number 10051789-01, filed on the same day as the present application.

In certain embodiments, the system of the invention contains an array fabrication station 550 and/or a probe fabrication station 560. In these embodiments, the system can fabricate one or more arrays and/or probes based at least in part on array content information sent to it from a user of the system. By “based at least in part” is meant that at least a part of the information required to fabricate an array and/or probe using a fabrication station of the subject system comes from an array content information entry stored in the database.

For example, a user of the system can select a number of probes that he/she wants included in an array and submits the array content information for these probes to the array layout developer 534 of the system. The array layout developer develops an array layout that includes these probes and forwards this array layout to the array fabrication station 550 for fabrication. In this example, the array layout developed by the array layout developer includes information derived from the array layout developer itself (e.g., feature spacing, feature size, probe position, etc.) as well as from the array content information selected and sent to the array layout developer (e.g., the probe sequences, target genes, etc.). As such, the array fabricated by the array fabrication system is “based at least in part” on the array content information for the probes selected by the user.

Fabrication of probes and/or arrays using systems of the invention is discussed in greater detail below.

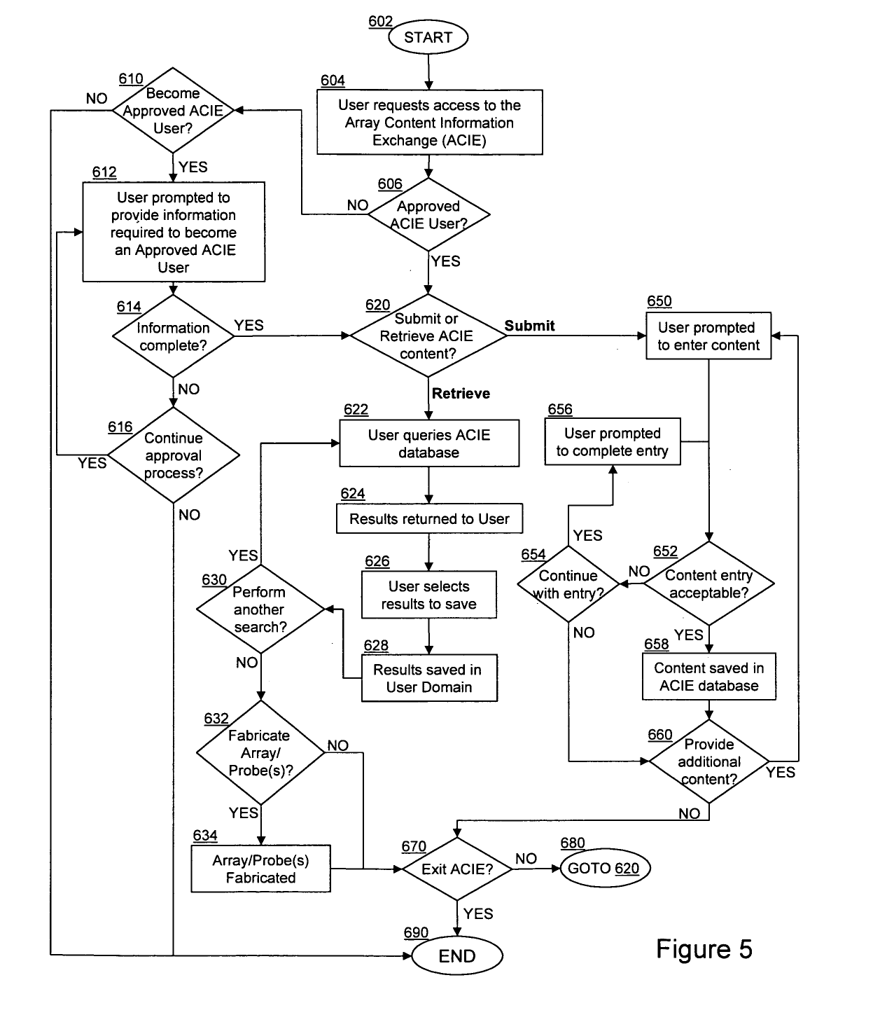

A flow diagram implementing certain aspects of the invention is provided in FIG. 5. As such, a system of the invention may include additional aspects and/or exclude certain aspects shown in FIG. 5 (and discussed below).

At step 604, a user requests access to the array content information exchange (ACIE) system. At decision box 606, the system determines whether the user is an approved user. In certain embodiments, the system may request a user to input a user ID and a password to confirm that the user is an approved user of the ACIE system. In certain other embodiments, the system may automatically receive verification from the computer of an approved user (e.g., using a cookie) without requiring additional user input.

If the user is not an approved user, the user is asked whether he/she wants to become an approved user at decision box 610. If “no”, the process ends at step 690. If “yes”, he/she is prompted to provide qualifying information at step 612. By qualifying information is meant any user-specific information or combination of user-specific information that the system requires for a user to access the ACIE system. The type of qualifying information can be virtually any user-specific information that the administrator and/or operator of the system deems necessary for gaining access to the ACIE system. For example, in certain embodiments qualifying information includes one or more of the following: name, email address, contact information (e.g., work telephone number), affiliation, job title, mailing address, etc. If a user of the system has a prior relationship with the operator of the system (e.g., a user is a customer of the operator), the user-specific information may be in the form of a user-specific ID that has been previously assigned to the user (e.g., a customer number). In certain embodiments, the system may provide different levels of access to the system which require different types of qualifying information. For example, if a user merely wants to search and submit array content information but not use the array layout developer to develop an array layout (discussed below), the system may not require as much qualifying information.

Once the user provides the qualifying information at step 612, the system checks whether the qualifying information is complete at step 614, and if it is not, it asks the user whether he/she wants to continue the approval process at decision box 616. If “no”, the user exits the system at step 690. If “yes”, the system prompts the user to provide the missing information at step 612. Upon providing the required qualifying information, the user is approved to access the system (at decision box 620).

Decision box 620 represents the start of a user session in the ACIE system. A session is terminated when the user exits the ACIE system by selecting “yes” at decision box 670. Therefore, a single user session is not limited by the number of steps performed in the system, and as such can include any combination of steps.

At decision box 620, a user decides to submit or retrieve (e.g., search for) array content information (i.e., the user performs an array content information request).

If submitting array content information, the system prompts the user to enter the array content information to be submitted (i.e., stored) in the ACIE database at step 650. As described above, array content information can be a wide variety of array-level and/or probe-level information. In certain embodiments, a user may submit probe-level information for one or a number of probes that find use in the detection of a specific transcript and/or gene in an organism of interest. In certain other embodiments, a user may submit array-level information for an array (or portion thereof) that finds use in tracking a specific cellular process, disease state or therapeutic response, genetic content, etc. Given the wide variety of information that a user can submit to the ACIE, he/she may be prompted to select the specific type of array content information that they wish to submit (e.g., probe-level or array-level) prior to submitting the specific information.

In certain embodiments, array content information submitted to the system is categorized and/or ranked. For example, array content information can be categorized as unverified, verified, and certified array content information. By “unverified” is meant an array content information submission that can be submitted by any user of the system and viewed by any user of the system with little or no restriction or review by the operator and/or administrator of the system. By “verified” is meant an array content information submission for which the submitting user has a certain level of annotation and/or associated documentation attached to it. In certain embodiments, the annotation and or associated documentation is not reviewed or validated by the operator and/or administrator. By “certified” is meant an array content information submission that has been confirmed to function as indicated (e.g., has been tested experimentally) either by the operator/administrator of the system or by a third party certified by the operator/administrator of the system to perform this function.

In certain embodiments, the system includes the username or other user identifier (e.g., a system-generated user number) of the user who submitted the array content information to the system as part of the array content information stored in the ACIE database. Having the username (or other user identifier) saved with each array content information submission provides for additional functionality of the system. For example, having a username included as part of the array content information stored in the ACIE database allows a user to query the system for array content information submitted by a specific user or users. It also allows for additional control of the ACIE database by a system administrator.

In certain embodiments, the user indicates whether the array content information is freely-accessible (non-proprietary) or whether it is restricted-access (proprietary) array content information. As indicated above, freely-accessible array content information means that any user of the system can view and/or use the array content information without any payment of fees and/or agreeing to terms of use as specified by the user who submitted the array content information. Also as indicated above, restricted-access array content information means that the user who submitted the array content information has placed a restriction as to viewing and/or using the array content information. In certain embodiments, restricted-access array content information means that certain of the fields are not viewable by other users of the ACIE system. For example, a user may restrict other users of the ACIE system from viewing the sequence of a probe while allowing them to view information regarding the target gene for which the probe is specific and/or other probe-level information (e.g., probe annotation information).

Once the user has entered the array content information, the system determines whether the array content information submitted is acceptable (e.g., complete enough for addition to the ACIE database). If it is not, the system alerts the user that the array content information entry is incomplete and asks the user whether or not he/she wishes to provide the missing array content information at decision box 654. If “no”, the user is routed to decision box 660 (described below). If “yes”, the system prompts the user to complete the array content information entry at step 656. This step may be accomplished by any convenient method. For example, if the user entered the array content information in a system-generated graphic (e.g., web graphic) having specific fields in which to enter the array content information, the system may re-display this graphic to the user with the missing required information highlighted in some way (e.g., a red asterisk next to the required missing field(s)). The user then enters the missing required information and re-submits the entry to the system. This process is reiterated until the array content information provided by the user is complete (i.e., all of required fields are filled in by the user). When the array content information entry is complete (whether on the first or subsequent rounds of array content information entry), it is saved to the ACIE database at step 658.

Once the array content information is stored in the ACIE database (i.e., after step 658) or the user has decided to terminate an incomplete entry (i.e., if “no” at decision box 654), the user decides whether to submit any additional array content information at decision box 660. If “yes”, the user is routed back to step 650 and prompted to enter the additional array content information. If “no” the user decides whether to exit the ACIE system at decision box 670. If “yes”, the user exits the system and the session ends at step 690. If “no”, the user is routed back to decision box 620 (step 680).

If a user decides to retrieve array content information from the database at decision box 620, the user queries the ACIE database at step 622. A user may query the ACIE database for any type of array content information, e.g., array-level and/or probe-level information, for which the user has an interest. For example, a user may query for an array layout that finds use in assaying for a specific process in a cell(s) of interest (e.g., activation of murine T cells). In another example, a user may enter a gene of interest for which specific probes are sought. Further, a user may query the database for array content information that meets several specific criteria, e.g., an array that finds use in assaying a specific cellular process and having probes for a specific gene or subset of genes. As such, the specificity and/or complexity of the query is determined by the user.

In certain embodiments, a user is able to retrieve array content information based on the category of array content information that the user has submitted to the system (see above for description of examples of categories). For example, if a user has submitted certified array content information to the system (either proprietary or non-proprietary), that user has access to all of the array content information contained in the system. If a user has submitted verified array content information to the system, that user has access to verified and unverified array content information contained in the system (i.e., the user cannot retrieve certified array content information). If a user has submitted only unverified array content information to the system, that user has access only to unverified array content information contained in the system.

At step 624, the system returns results of the query to the user. The results may be displayed to the user in any convenient manner. For example, the results may be displayed as a web graphic having a list or returned query results, e.g., a list with the most relevant hits shown first. In certain embodiments, each of the results returned may be displayed as active hyperlinks that, when selected, display additional (or all) of the array content information in the entry. For example, selecting a specific probe in a list of probes returned in response to a user query (e.g., clicking on the hyperlinked probe name in the list on the web graphic) displays to the user the array content information entry. In certain embodiments, the information displayed to a user upon selecting a specific hyperlinked query result includes some or all of the array content information specific to that array content information entry depending in part on whether the array content information is proprietary or non-proprietary. In certain embodiments, the information displayed to a user upon selecting a specific hyperlinked query result includes information not submitted as part of the original array content information entry. For example, if a user selects a probe from a list returned in response to a query (e.g., a query for a probe specific for a gene of interest), the system may provide a list of array layouts in the ACIE database that include that probe. In addition, the system may provide a list of probes specific for genes related to the gene of interest (e.g., if a user queries for a probe specific for the T cell activation marker CD69, the system may provide a list of other T cell activation markers that may be of interest to the user, e.g. CD25). As such, the ACIE database may provide additional functionality beyond merely returning results that meet a specific query.

At step 626, the user selects which, if any, of the results returned in response to the query to save. In certain embodiments, the selected results are saved in a user domain. In certain embodiments, a graphical display of the returned results (e.g., in the form of web page content on a graphical user interface in communication with the output manager) may include a box that when selected by a user (e.g., by clicking in the box) indicates that the user wants this result to be saved in the user domain. Any convenient method for selecting a displayed query result (or multiple results) may be employed. At step 628, results that have been selected by the user to be saved are stored by the system in the user domain, e.g., by selecting/clicking on a “save” icon displayed on the graphical display of the results.

In certain embodiments, the user domain is a memory location contained within the system (500), whereas in other embodiments, the user domain is a memory location in the user computer (510).

In certain embodiments, the user domain is a temporary memory location, e.g., a cache, that is maintained for a specific user during a single session in the ACIE system: In these embodiments, once the user exits the ACIE system (i.e., once a session is terminated at step 690), the information in the user domain is deleted. In certain other embodiments, the user domain is a stable (or long term) memory location that is maintained between ACIE system sessions. In certain of these embodiments, the user domain is maintained in the ACIE system for as long as the user has an active ACIE account (e.g., as long as the user is an approved user of the ACIE system). In certain embodiments, the information stored in a specific user domain can be accessed only by the user for which it was created. In certain other embodiments, a user domain can be accesses by other users of the system, e.g., other users that have been given access to the user domain either by the user for which the user domain was created or by the system administrator.

Regardless of whether array content information is selected and saved at steps 626 and 628, the user decides whether or not to perform additional queries of the ACIE database at decision box 630. If “yes”, the user is routed to step 622 to start another query. In certain embodiments, any results retrieved from subsequent queries that are of interest to the user (e.g., selected) may be added to any previous results saved in the user domain. In this way, a user can accumulate array content information of interest using a number of distinct search strategies. For example, a user of the ACIE system can search for probes specific for multiple genes of interest by iteratively searching the ACIE database for probes specific for each gene and saving the desired results in the user domain after each query. As indicated above, in certain embodiments, the user domain maintains array content information between ACIE system sessions, allowing the user to perform searches and save relevant results over time.

Once a user has completed searching for array content information, i.e., selects “no” at decision box 630, the user decides whether to have fabricated arrays of probes and/or free probes (i.e., probes not on a substrate in the form of an array) based on all or a portion of the array content information saved in the user domain. If the user does not want to have an array and/or probe fabricated, then the user is routed to decision box 670 and decides whether to exit the ACIE system. In certain embodiments, selecting “no” at decision step 632 does not preclude a user from fabricating an array and/or a probe based on the array content information saved in the user domain during the current session. For example, a user may save array content information in the user domain over the course of several distinct ACIE sessions before using this saved array content information to fabricate a probe and/or array (or multiple probes and/or arrays).

In certain embodiments, the user may choose to obtain a probe(s) and/or array(s) based on some or all of the array content information saved in the user domain. For example, a user may select one or more probes and/or one or more array layouts to be fabricated. In certain embodiments, a user may want to have a new or modified array layout developed prior to fabrication based on selected array content information saved in the user domain (e.g., specific probes or array layouts). For example, a user may save array content information for a number of specific probes in the user domain for which an array layout has not previously been developed. In this case, the user has the array layout developer (534) of the processing module (530) of the system develop a new array layout that includes these probes. In certain embodiments, the user may decide not to have the new array layout fabricated and instead request that the array layout developer develop yet another new array layout based upon additional and/or modified array layout and/or array content information. For example, a user may include or exclude specific array content information and/or modify or provide additional array layout or format information (e.g., feature size, feature location, etc.) that will be included in the new array layout developed by the array layout developer. As such, the development of a new array layout based at least in part on array content information in the user domain may be an iterative process in which a user requests an array layout to be developed by the array layout developer, receives the array layout result, provides additional array content and/or array layout information, and resubmits this information to the array layout developer to develop yet another new array layout. Virtually any combination of array content information may be selected by a user to develop one or more array layouts using the array layout developer of the system. One example of an array layout developer that finds use the subject invention is described in U.S. patent application Ser. No. 11/349,452, filed on Feb. 6, 2006, which is incorporated herein by reference in its entirety. However, other array layout developers also find use in the systems of the invention, and as such no limitation in this regard is intended.

Probe and/or array fabrication can be accomplished using any convenient method. For example, free probes (i.e., probes not bound to a substrate) can be synthesized using standard phosphoroamidite synthesis protocols.

With respect nucleic acid arrays in which the immobilized nucleic acids are covalently attached to the substrate surface, such arrays may be synthesized via in situ synthesis in which the nucleic acid ligand is grown on the surface of the substrate in a step-wise fashion and via deposition of the full ligand onto the surface of the array, e.g., in which a presynthesized nucleic acid/polypeptide, cDNA fragment, etc.

Where the in situ synthesis approach is employed, conventional phosphoramidite synthesis protocols may be used. In phosphoramidite synthesis protocols, the 3′-hydroxyl group of an initial 5′-protected nucleoside is first covalently attached to the polymer support, e.g., a planar substrate surface. Synthesis of the nucleic acid then proceeds by deprotection of the 5′-hydroxyl group of the attached nucleoside, followed by coupling of an incoming nucleoside-3′-phosphoramidite to the deprotected 5′ hydroxyl group (5′-OH). The resulting phosphite triester is finally oxidized to a phosphotriester to complete the internucleotide bond. The steps of deprotection, coupling and oxidation are repeated until a nucleic acid of the desired length and sequence is obtained. Optionally, a capping reaction may be used after the coupling and/or after the oxidation to inactivate the growing DNA chains that failed in the previous coupling step, thereby avoiding the synthesis of inaccurate sequences.

In the synthesis of nucleic acids on the surface of a substrate, reactive deoxynucleoside phosphoramidites are successively applied, in molecular amounts exceeding the molecular amounts of target hydroxyl groups of the substrate or growing oligonucleotide polymers, to specific cells of the high-density array, where they chemically bond to the target hydroxyl groups. Then, unreacted deoxynucleoside phosphoramidites from multiple cells of the high-density array are washed away, oxidation of the phosphite bonds joining the newly added deoxynucleosides to the growing oligonucleotide polymers to form phosphate bonds is carried out, and unreacted hydroxyl groups of the substrate or growing oligonucleotide polymers are chemically capped to prevent them from reacting with subsequently applied deoxynucleoside phosphoramidites. Optionally, the capping reaction may be done prior to oxidation.

With respect to actual probe and/or array fabrication, in certain embodiments, the user may himself produce a probe and/or an array based on the array content information retrieved from the system (e.g., saved in the user domain). In yet other embodiments, the user may forward the array content information to a specialized array fabricator or vendor, which vendor will then fabricate the probe(s) and/or array(s) according to the array content information.

In yet other embodiments, the system may be in communication with a probe fabrication station 560 and/or an array fabrication station 550, e.g., where the system operator is also a probe and/or array vendor, such that the user may order a probe and/or an array directly through the system. In response to receiving an order from the user, the system will forward the array content information to the appropriate fabrication station, and the fabrication station will fabricate the probe/array according to the forwarded array content information.

Arrays can be fabricated using drop deposition from pulsejets of either polynucleotide precursor units (such as monomers) in the case of in situ fabrication, or the previously obtained polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein. Also, instead of drop deposition methods, light directed fabrication methods may be used. Interfeature areas need not be present particularly when the arrays are made by light directed synthesis protocols.

Following fabrication, the fabricated probe and/or array may then be forwarded, i.e., shipped, to the user using any convenient means. As such, following fabrication, one or more probes and/or array units may then be forwarded to one or more remote customer stations.

In certain embodiments, a new array layout developed at the request of a user (i.e., developed by the array layout developer 534) is saved in the ACIE database as a new array content information entry. In certain embodiments, saving a new array layout is done automatically by the system, whereas in other embodiments the new array layout is saved in the ACIE database at the request (or by permission) of the user who requested it to be developed. In certain embodiments, the user will be prompted to provide additional information for the new array layout before storing it in the ACIE database. For example, the user may be requested to input the utility of the array (e.g., a cellular process for which the array layout is particularly suited to assay) or other such information. As with other submissions of array content information (described above), the array content information stored in the ACIE database for the new array layout may include the user name (or other user identification) of the user that requested its development. While not explicitly shown in FIG. 5, a user can delete all or a portion of the array content information stored in the user domain. In certain embodiments, a user can select the array content information to be deleted from the user domain by checking a “delete” box next to the array content information displayed graphically to the user (similar to selecting array content information to be saved in the user domain, as discussed above). In certain embodiments, a user may delete all of the array content information saved in the user domain using a single command, e.g., a “delete all” box displayed on a graphical representation of the array content information stored in the user domain.

In certain embodiments, a user can delete and/or modify array content information stored on the ACIE database (540) which he/she has previously submitted. For example, a user may determine that a previously-submitted array content information entry is not accurate. For example, a user may find that the sequence of a probe submitted to the database has an error, that the gene for which the probe was stated to be specific was entered incorrectly, that the annotation of a probe has changed since being entered into the database, etc. In certain of these embodiments, approval of a system administrator may be required prior to altering or deleting array content information from the ACIE database.

In certain embodiments, the system is configured to allow a user of the system to submit comments on an array content information entry submitted by another user. Such comments may include, but are not limited to, the function of a specific probe or array (e.g., in diagnosing a disease state, in tracking a cellular process, in identifying a transcript or gene, etc.), specific hybridization conditions that work well (or that do not work well), unexpected cross-hybridization of a probe, or errors in the information in the array content information entry, etc. In essence, there is no limitation on the nature of a comment for an array content information entry submitted by a user. In certain embodiments, the comments are displayed to a user of the system when viewing the detailed information of the array content information (e.g., when a user selects a specific hyperlinked query result to see the entire array content information entry, as described above). In certain embodiments, an administrator of the system regulates the entry of a comment into the system (e.g., allows, rejects, or modifies a comment submitted to the system). In certain embodiments, the user that submitted the array content information may provide a response to the comment that will be displayed along with the comment submitted by another user.

In certain embodiments, the system is further configured to include a processing module with one or more of the following additional functionalities:

(i) a collaboration manager configured to allow at least two different users to jointly provide array content information to a single joint user domain (or to allow the sharing of array content information saved in two or more distinct user domains);

(ii) a security manager configured to control information transfer in a predetermined manner between at least two different user domains of two different users in the system; and

(iii) a vendor manager configured to provide access by a user to a service provided by at least one vendor.

In certain embodiments, the output manager further provides a user with information regarding how to purchase a probe(s) and/or array(s) according to the provided array content information. In certain embodiments, the array content information is provided in the form of an email. In certain embodiments, the information is provided in the form of web page content on a graphical user interface in communication with the output manager. In certain embodiments, the web page content provides a user with an option to select for purchase one or more synthesized probes and/or arrays. In certain embodiments, the web page content includes fields for inputting customer information. In certain embodiments, the system can store the customer information in the memory. In certain embodiments, the customer information includes one or more purchase order numbers. In certain embodiments, the customer information includes one or more purchase order numbers and the system prompts a user to select a purchase order number prior to purchasing the one or more synthesized probes and/or arrays.

Chemical arrays produced according to array layouts generated by the subject systems and methods find use in a variety of different applications, where such applications are generally analyte detection applications in which the presence of a particular analyte in a given sample is detected at least qualitatively, if not quantitatively. Any convenient method for carrying out such assays may be used. In certain of such methods, the sample suspected of comprising the analyte of interest is contacted with an array produced according to the subject methods under conditions sufficient for the analyte to bind to its respective binding pair member that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface.

Specific analyte detection applications of interest include hybridization assays in which the nucleic acid arrays of the subject invention are employed. In these assays, a sample of target nucleic acids is first prepared, where preparation may include labeling of the target nucleic acids with a label, e.g. a member of signal producing system. Following sample preparation, the sample is contacted with the array under hybridization conditions, whereby complexes are formed between target nucleic acids that are complementary to probe sequences attached to the array surface. The presence of hybridized complexes is then detected. Specific hybridization assays of interest which may be practiced using the subject arrays include: gene discovery assays, differential gene expression analysis assays; nucleic acid sequencing assays, and the like. Patents and patent applications describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992. Also of interest are U.S. Pat. Nos. 6,656,740; 6,613,893; 6,599,693; 6,589,739; 6,587,579; 6,420,180; 6,387,636; 6,309,875; 6,232,072; 6,221,653; and 6,180,351. In certain embodiments, the subject methods include a step of transmitting data from at least one of the detecting and deriving steps, as described above, to a remote location.

Where the arrays are arrays of polypeptide binding agents, e.g., protein arrays, specific applications of interest include analyte detection/proteomics applications, including those described in U.S. Pat. Nos. 4,591,570; 5,171,695; 5,436,170; 5,486,452; 5,532,128 and 6,197,599 as well as published PCT application Nos. WO 99/39210; WO 00/04832; WO 00/04389; WO 00/04390; WO 00/54046; WO 00/63701; WO 01/14425 and WO 01/40803—the disclosures of which are herein incorporated by reference.

As such, in using an array made by the method of the present invention, the array will typically be exposed to a sample (for example, a fluorescently labeled analyte, e.g., protein containing sample) and the array then read. Reading of the array may be accomplished by illuminating the array and reading the location and intensity of resulting fluorescence at each feature of the array to detect any binding complexes on the surface of the array. For example, a scanner may be used for this purpose which is similar to the AGILENT MICROARRAY SCANNER available from Agilent Technologies, Palo Alto, Calif. Other suitable apparatus and methods are described in U.S. Pat. Nos. 5,091,652; 5,260,578; 5,296,700; 5,324,633; 5,585,639; 5,760,951; 5,763,870; 6,084,991; 6,222,664; 6,284,465; 6,371,370 6,320,196 and 6,355,934. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample or an organism from which a sample was obtained exhibits a particular condition). The results of the reading (processed or not) may be forwarded (such as by communication) to a remote location if desired, and received there for further use (such as further processing).

The invention also provides programming, e.g., in the form of computer program products, for use in practicing the methods. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. Any convenient medium or storage method can be used to create a manufacture that includes a recording of the present programming/algorithms for carrying out the above described methodology.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A system for exchanging array content information, said system comprising:
(a) a database comprising array content information;
(b) a communication module; and
(c) a processing module comprising an array content information manager configured to process array content information requests of said database by a user.

2. The system of claim 1, wherein said array content information manager requires qualifying information from a user prior to processing array content information requests of said database by said user.

3. The system of claim 2, wherein said qualifying information is selected form the group consisting of: name, email address, affiliation, contact information, and job title.

4. The system of claim 1, wherein said array content information requests are selected from: submission of array content information, retrieval of array content information based on a query, deletion of array content information, modification of array content information, providing comments on array content information, and any combination thereof.

5. The system of claim 4, wherein said array content information manager is configured to require submission of array content information to said database by a user prior to allowing retrieval of array content information from said database in response to a query from said user.

6. The system of claim 1, wherein said array content information comprises probe-level information.

7. The system of claim 6, wherein said probe-level information is selected from: sequence, annotation, length, target binding characteristics, and any combination thereof.

8. The system of claim 1, wherein said array content information comprises array-level information.

9. The system of claim 8, wherein said array-level information is selected from: probe-specific information for at least a subset of probes on an array, intended use of an array, target organism, array layout, protocol for using an array, and any combination thereof.

10. The system of claim 1, wherein said array content information manager is configured to communicate retrieved array content information in response to a query from a user.

11. The system of claim 10, wherein said retrieved array content information can be selected by said user.

12. The system of claim 11, wherein said system further comprises a user domain for said user, wherein said array content information manager stores said retrieved array content information selected by said user in said user domain.

13. The system of claim 12, wherein said system further comprises an array layout developer, wherein said array layout developer develops an array layout based at least in part on said stored array content information in said user domain when prompted by said user.

14. The system of claim 13, wherein said array content information manager communicates said developed array layout to said user.

15. The system of claim 14, wherein said array content information manager stores said developed array layout in said user domain when prompted by said user.

16. The system of claim 14, wherein said system further comprises an array fabrication module, wherein said array fabrication module fabricates at least one array based on said developed array layout when prompted by said user.

17. The system of claim 4, wherein said array content information manager prompts a user to complete an incomplete array content information submission prior to storing said array content information submission in said database.

18. The system of claim 1, wherein said array content information comprises proprietary or non-proprietary array content information.

19. The system of claim 1, wherein said array content information comprises proprietary and non-proprietary array content information.

20. The system of claim 1, wherein said array content information manager is configured to be controlled by an administrator of said system.

21. The system of claim 1, wherein a first user can access array content information in said database submitted by a second user.

22. The system of claim 1, wherein said communication module is configured to provide for remote communication between said processing module and a user.

23. The system of claim 22, wherein said communication module provides for communication between said user and said processing module via the Internet.

24. The system of claim 23, wherein said communication module provides for a graphical user interface (GUI) between said user and said processing module.

25. A method of exchanging array content information, said method comprising:
(a) accessing system for exchanging array content information, said system comprising:
(i) a database comprising array content information;
(ii) a communication module; and
(iii) a processing module comprising an array content information manager configured to process array content information requests of said database by a user; and
(b) submitting an array content information request to said system.

26. The method of claim 25, wherein said accessing is via the Internet.

27. The method of claim 25, wherein said accessing is via a graphical user interface.

28. The method of claim 25, wherein said accessing requires providing qualifying information.

29. The method of claim 25, wherein said array content information request is selected from the group consisting of: submission of array content information, retrieval of array content information based on a query, deletion of array content information, modification of array content information, and providing comments on array content information.

30. The method of claim 25, wherein said array content information comprises probe-level information.

31. The method of claim 30, wherein said probe-level information is selected from the group consisting of: sequence, annotation, length, and target binding characteristics.

32. The method of claim 25, wherein said array content information comprises array-level information.

33. The method of claim 32, wherein said array-level information is selected from the group consisting of: probe-level information for at least a subset of probes on an array, intended use of an array, target organism, array layout, array format, and protocol for using an array.

34. A method of producing an array layout for a chemical array, said method comprising:
(A) accessing system for exchanging array content information, said system comprising:
(i) a database comprising array content information;
(ii) a communication module; and
(iii) a processing module comprising:
(a) an array content information manager configured to process array content information requests of said database by a user; and
(b) an array layout developer;
(B) retrieving array content information;
(C) prompting said system to develop an array layout based at least in part on said retrieved array content information; and
(D) obtaining an array layout from said system to produce said array layout.

35. The method of claim 34, wherein said accessing is via the Internet.

36. The method of claim 35, wherein said accessing is via a graphical user interface.

37. The method of claim 34, wherein said method further comprises fabricating one or more chemical arrays having said array layout.

38. The method of claim 37, wherein said method further comprises shipping said one or more chemical arrays to a user.

39. A computer program product comprising a computer readable storage medium having a computer program stored thereon, wherein said computer program, when loaded onto a computer, operates said computer to:
(a) establish a database comprising array content information; and
(b) process array content information requests of said database by a user.
